(19) United States
(12) Patent Application Publication
(10) Pub. No.: US 2006/0235899 A1
(43) Pub. Date: Oct. 19, 2006

(54) Method of migrating legacy database systems

(75) Inventor: David Tucker, (US)

Correspondence Address: JACKSON WALKER L.L.P., Suite 2100, 112 E. Pecan Street, San Antonio, TX, 78205, US

(73) Assignee: FRONTLINE SYSTEMS, INC.

(21) Appl. No.: 11/389,936

(22) Filed: Mar. 27, 2006

Related U.S. Application Data
(60) Provisional application No. 60/665,494, filed on Mar. 25, 2005.

(51) Int. Cl. G06F 17/30

(52) U.S. Cl. 707/200

(57) ABSTRACT

A system and method for migrating legacy database systems to modern database comprises generally of the steps of gathering design information about the legacy database system; analyzing the metadata, data fields, and processes of the legacy system; iteratively creating business objects to represent the migrated data; iteratively associating each of the fields of the legacy database system to one or more of the business objects; creating a data migration script to effect the migration of data; and resolving inconsistencies between the legacy database systems and the one or more target database systems.

This application claims priority from U.S. Application No. 60/665,494 filed Mar. 25, 2005 and incorporates by reference the '494 application as if it were fully printed herein.

### FIELD OF THE INVENTION

Applicant's invention relates to a database migration system. More particularly, Applicant's invention relates to an interactive iterative method of migrating legacy database systems to modern database systems.

### BACKGROUND OF THE INVENTION

Database migrations are initiated for a variety of reasons. Sometimes they are done for increased performance. If database loads or nightly database refreshes are taking too long, then a new server with more or faster CPUs may help. Sometimes they are done for data reorganization. Sometimes migrations are done as part of server consolidation projects, where entire departments move their databases to a single server. Often, it's just a simple matter of economics. The original environment may have become too costly due to high maintenance costs, or the new environment may offer lower software licensing costs.

Regardless of the motivation, it is a fairly common event in a database's lifecycle that it will be subject to migration from an “older” version to a “newer” version. Migrating from one version to another may be as simple as exporting the old and importing into the new with little to no changes to the underlying schema. More often than not, however, the migration of an older database to a newer database involves significant modifications to the underlying schema and changes to the underlying platform. Often, the migration involves a shift in database technology (e.g. from relational to objected-oriented).

A number of methods for the migration of legacy databases have been proposed and attempted. However, on large-scale systems, most have met with lukewarm success or outright failure.

One reason for the failure of a typical database migration project is that there is often little to no documentation describing the legacy database system, either structurally or functionally. Typically, the only documentation for legacy database systems is the database schema itself and the system's supporting code. The original implementors of the legacy database system typically have long since departed. Documentation is often non-existent, out of date, or lost. The original specifications and coding practices are now considered primitive or bad. Often, legacy code was written for high performance on some extinct or archaic computer resulting in arcane code constructs.

In such situations, the function of the legacy database system must be decrypted from the existing source code and database schema if it is to be understood or copied in the target database system. This adds greatly to the complexity and cost of developing the target database system and migrating the legacy database system thereto.

Another reason for failure of a typical database migration project is that are often undocumented dependencies, both internal and external, within the legacy database system. Applications, from non-critical to mission critical, access the legacy database system for its mission critical information and other resources. Over the life of a legacy database system, the number of these dependent applications grows, some of which may be unknown to the legacy database system administrators. The process of migrating legacy database systems must identify and accommodate these dependencies. This adds to the complexity of the migration and raises the risk of failure.

It is therefore an object of the present invention to provide a method and system for examining, analyzing, and migrating data from one or more legacy database sources into a new integrated enterprise environment.

It is a further object of the present invention to provide a system and method that connects to legacy Java Database Connectivity (JDBC) or Open Database Connectivity (ODBC) database systems using standard methods to retrieve the tables, fields, indexes and other schema data available for the legacy database system and provides an intuitive, interactive system for creating target business objects and migrating the legacy database system to the target database system.

### SUMMARY OF THE INVENTION

In accordance with the present invention, a legacy database migration system and method is provided for examining, analyzing, and migrating data from multiple legacy data sources into a new integrated enterprise environment.

In one embodiment, the system incorporates a Graphical User Interface (GUI)-based application that can connect to available legacy JDBC or ODBC databases. The system uses standard methods to retrieve the identifiers of tables, fields and indexes (collectively, metadata) available in the legacy databases. A user of the system need not know the details of the legacy database, except, generally, how to connect to the database. The system automatically determines what data elements are available in the legacy database system.

The system stores the metadata information it retrieves in a metadata database for later use. In one embodiment of the current system, the storage of the retrieved metadata is made in compliance with the ISO-11179 standard as defined by the International Organization for Standardization.

The system also generates Structured Query Language (SQL) statements that can be used to create an image of the legacy database in a test environment, and, where appropriate, generates JavaBean or other source code for software components that can be used later in the process for operating on the actual data from the legacy database.

The system allows a database, systems, or business analyst to view and analyze information about the legacy database system. Legacy information is represented in a graphical, easily navigated tree. The analyst can create new data containers, typically represented as business objects, that that may be better organized or structured, or may contain information from many of these legacy databases. The analyst can also specify which legacy data fields should be migrated to which of these new enterprise data containers by dragging and dropping fields from the legacy databases onto the new data containers.

With legacy and enterprise data specifications displayed to the analyst, the analyst can drag-and-drop data elements from the legacy database system, onto the business objects of the target enterprise database system, and specify data migration information such as data transformations to apply. The drag-and-drop feature may be implemented by representing the legacy database system in one tree object (similar to a directory tree as represented in the Microsoft® Windows® Explorer) and the target enterprise database business objects in a second tree object.

An analyst may drag a legacy database field from the legacy tree and drop it on an enterprise business object or an attribute within an enterprise business object, thus indicating the desired data migration of that legacy database field into the target enterprise database architecture. A set of standard transformations between underlying data types is typically created in the metadata database. If a default transform fits the legacy and target data-types, the transform is assumed as the default. If no default transform is available, the analyst must define a new transformation algorithm or acknowledge that no transformation currently exists and must be created before the data may be migrated.

To facilitate working with potentially very large sets of metadata (a typical database migration project may comprise tens of thousands of data fields in hundreds of tables across dozens of legacy data systems) various techniques are used to help the analyst find related data elements to migrate to the target business objects. Among these methods are: legacy proximity, semantic similarity, and distributional similarity.

Legacy proximity is the trivial relationship where, if one data element from a table is migrated to a particular business object, it is probable that other data elements from the same legacy table should also be migrated to this particular business object. To work with this relationship, a three-tree representation is used. One tree is the legacy metadata tree. The second tree is a business object tree, restricted to the particular business object. The third tree is a sources tree, showing all legacy data tables with elements migrated onto the selected business object attribute in the business object tree. When the analyst selects a legacy data element or business object attribute, the two related trees are updated to show all associations previously established for the selected item. Other potential associations among legacy data elements can be found by the analyst in studying data elements residing on legacy tables from which one (or more) data elements have already been linked to the business object currently represented in the business object tree.

Semantic similarity uses a rule set which utilizes the description and definition fields of legacy data elements to attempt to find other legacy data elements that contain the same or related data. In this approach, an inventory of words and word frequencies is built by tokenizing all description and definition fields in the legacy database system.

The number of terms shared between two legacy data elements is assumed to be predictive of whether the two data elements should be migrated to the same target business object attribute. A semantic similarity tree is constructed so, for each data element, it is either a level one (top level) node, or is under a node with which it is closest semantically based on word count and the relative distance of tokens from one another in the descriptions of the variables being compared. Thus, an analyst can traverse a branch of the semantic similarity tree containing data elements with semantically similar textual descriptions or definitions, and link these presumably similar data elements to the same business object attribute very quickly.

As part of the semantic similarity process, words which tend to be adjacent if they appear in the same definition may be joined into a “co-term” with additional semantic weight. For example, the terms “first” and “name” may each appear independently in some number of data element descriptions, but when they appear in the same description, they tend to be adjacent and form a single semantic unit, “first name.” This unit is of greater importance semantically because of the relationship between the two tokens, and when seen adjacent to one another in more than one field description, there is a significant probability that the data elements are describing the same piece of information, thus should be migrated to the same target business object attribute.

Tokenizing and the determination of similarities occur in various contexts which result in a tree of semantically similar data elements. One variation of the similarity tree uses a subset of tokens that the data analyst specifies as “knowledge domain driver terms.” For example, in mortgage banking, knowledge domain driver terms might include “mortgage,” “borrower,” “property,” “address,” etc. These terms become the level one (top level) nodes of the contextual semantic similarity tree. All legacy elements are then placed in a minimum spanning tree (a minimum-weight tree in a weighted graph which contains all of the graph's vertices) under the driver term, if and only if the driver term is present in the data element description. This refinement partially solves problems where the driver terms, which occur with high frequency in the data domain, skew the quality of the semantic similarity minimum spanning tree.

Distributional similarity compares the distribution of values among data elements and business object attributes. Where those distributions contain frequencies and variances that suggest a coded value (e.g., ‘M’ and ‘F’), the system prompts the analyst to examine the distribution and, if appropriate, create a “valid value table” for the values of the data element. A “valid value table” is a table within a database which stores all of the values which are valid values for a particular field or column in another table. If a valid value table containing similarly distributed values has already been created, the system will propose this similar table as a default valid enumerated value list for the current element.

An instance of two or more legacy data elements sharing similar value distributions (paraphrased as two or more variables taking values from the same valid value list) is believed to be predictive that the data elements should be migrated to the same target business object attribute. The system will present to the analyst lists of legacy data elements and business object attributes that share the same valid value list or a mapping onto a valid value list. Thus, when an analyst creates a business object attribute “gender,” containing coded values ‘M’ for Male and ‘F’ for Female, the system can search for legacy data elements containing variables with distributions containing exclusively the characters ‘M’ and ‘F’.

Further, through the transformation data captured from the analyst, if a legacy variable contains, for example, the value ‘1’ for Male and the value ‘2’ for Female, and a transformation from the 1/2 valid value list onto the M/F valid value list exists, the system will include the 1/2 coded legacy field along with any M/F fields it finds. This distributional technique allows the analyst to discover instances of valid value lists, compare distributions between legacy data elements, and find and link elements containing the same data irrespective of the underlying coding scheme.

The system uses the defined data migration/transformation information along with the data specifications it has extracted from the legacy databases, and the enterprise data containers the analyst has designed, to copy data from the legacy systems into the new enterprise system, applying data transformations as required.

This migration is accomplished through the production of a data migration script which defines an Extract-Transform-Load (ETL) migration whereby data is extracted from the legacy database system; the data is transformed, where needed; and the transformed data is loaded into the target enterprise database system. The migration script specifies the connection string (provided when the legacy metadata was extracted from the legacy database system), a table name and a SQL query string for extracting data from the table, a set of business objects into which the data is to be posted, and a set of from-to steps indicating which legacy data field is to be copied to which target business object attribute. The migration tool automates the extraction and copying of legacy data into the enterprise business objects, using, for example, Java Beans automatically created from the schemas of the legacy database system, and enterprise business objects as specified by an analyst.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating a system of the present invention.

FIG. 2 is a flowchart of processing performed by the present invention.

FIG. 3 is a flowchart of processing performed by a second embodiment of the present invention.

FIG. 4 is a flowchart of the processing of gathering system documentation and knowledge of the legacy database system.

FIG. 5 is a flowchart of the process of extracting metadata and connection information from the legacy database system.

FIG. 6 is a flowchart of the process of building a knowledge base of the legacy database system.

FIG. 7 is a flowchart of the process of identifying data and process associations.

FIG. 8 is a flowchart of the process of creating business objects and attributes therein.

### DETAILED DESCRIPTION

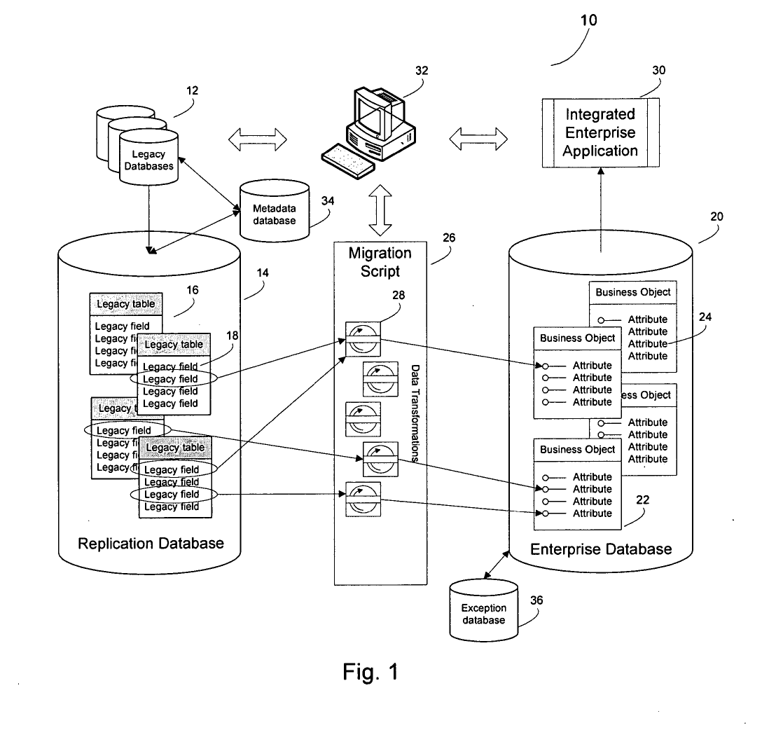

Referring to the figures in which like referenced features indicate corresponding elements throughout the several views, attention is first directed to FIG. 1 which depicts a block diagram illustrating a system (10) of the present invention. Legacy databases (12) store the data that is desired to be migrated to a more modern database system. As part of the migration effort, the schema and data of the legacy databases (12) are copied into a replication database (14). The replication database base (14) is intended to prevent any unwanted or accidental modification to the production versions of the legacy databases (12) during the migration process. It is seen that a copy is made of each relevant legacy table (16). Legacy tables (16) are comprised of legacy fields (18). “Fields” as used herein are analogous to “columns” as used in standard relational databases. The data of the legacy databases (12) is copied into the appropriate legacy fields (18) prior to migration.

A target enterprise database (20) is provided which is the location to which the data of the legacy databases (1 2) is to be migrated. Although the data within the target enterprise database (20) may be of any standard or customized database form, in one embodiment of the present invention, the data of the target enterprise database (20) will be accessed through business objects (22). As will be discussed in more detail below, business objects (22) are defined and created in the analysis phase (Phase 2, Step 110) of the migration process of the current system (10) and are objects in a computer program that abstract the entities and functions in the domain that the program is written to represent. Business objects contain business data and typically model a business behavior. Each business object (22) will be comprised of attributes (24) which store information migrated from the legacy fields (18) of the legacy databases (12).

The migration of the legacy data from the legacy fields (18) to the attributes (24) of the business objects (22) is accomplished through the execution of a migration script (26). The migration script (26) is a product of the analysis and mapping phases (Phase 3) of the migration process of the current system (10). The migration script (26) is comprised of mappings of legacy fields (18) to attributes (24) of business objects (22). Where appropriate, the migration script (26) causes the data of the legacy field (18) to pass through a data transformation module (28) before storing the transformed data in an attribute (24) of a business object (22). An example of such a transformation includes a transformation of one representation of an enumerated data type (e.g., 1/2 for Male/Female) to another representation (e.g., “M” and “F”). Although it is typical that data will be passed through a data transformation module (28) during the migration process, it is not mandatory. Where the data type of the legacy field (18) precisely matches the data type of the attribute (24) of the business object (22), it is not necessary to pass the data through data transformation module (28). For example, if the legacy field (18) and the target attribute (24) are both long integers and both the legacy system (12) and the target enterprise system (20) are “big endian” (i.e., the low-order byte of the number is stored in memory at the lowest address, and the high-order byte at the highest address), then the data in the legacy field (18) may be copied without passing through a data transformation module (28).

The newly migrated enterprise database (20) is then accessible by any of a number of enterprise applications (30). Each subsystem of the system (10) is accessible by an analyst or user via a computer terminal (32).

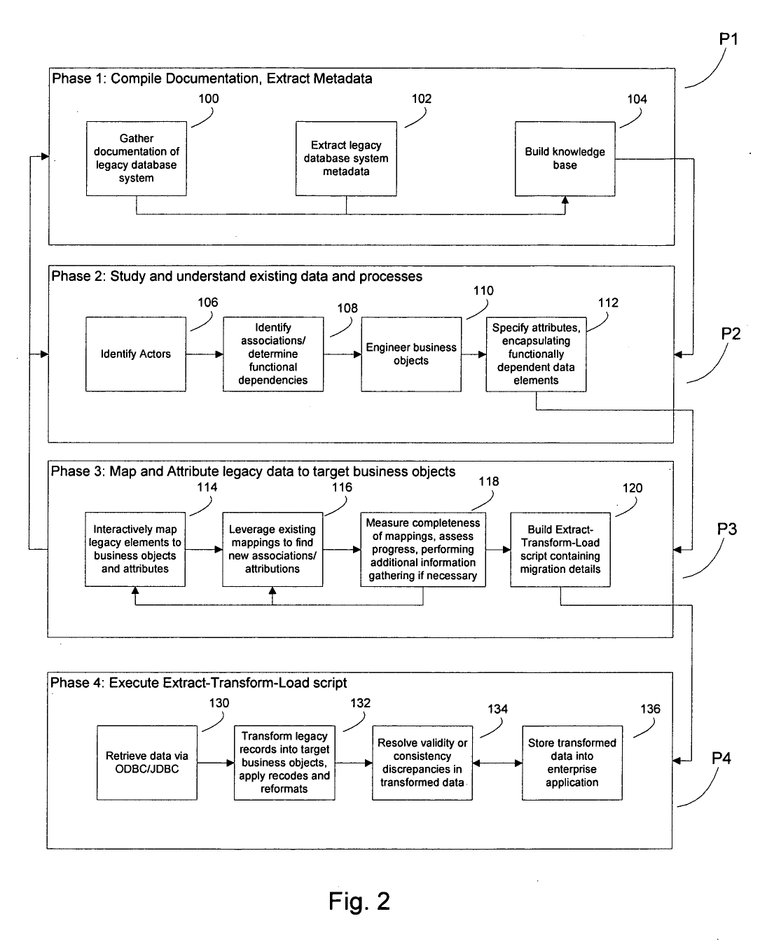

Referring now to FIG. 2, it is seen that the method of the current system (10) is comprised essentially of four phases. In Phase 1 (P1), the requirements of the migration are gathered. In this phase, baseline information is gathered from the client and the legacy database system which will illustrate the scope and complexity of the integration project. In Phase 2 (P2), an iterative process of requirements analysis is performed. Business objects are defined and created based upon an analysis of the entity's business functions. Functional dependencies (i.e., data that is grouped with or is determined by other data) are identified. Attributes for business objects are created in keeping with database principles such as normalization, storage and retrieval efficiency, and the like. In Phase 3 (P3), legacy database fields (18) are mapped to business objects (22) and attributes (24) therein and a migration script (26) is created. Finally, in Phase 4 (P4), the created migration script (26) is executed thereby migrating data from the replication database (14) to the enterprise database (20), the results of the migration are verified, ensuring that the data of legacy fields (18) were properly migrated to the attributes (24) of the business objects (22), and any inconsistencies are resolved or intentionally ignored.

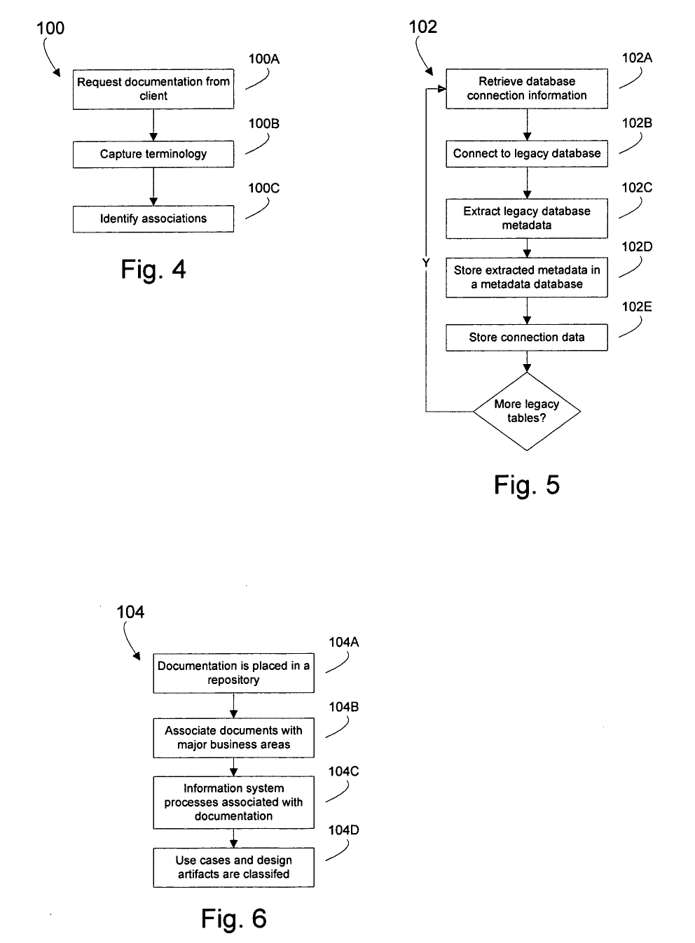

Referring back to Phase 1 (P1) of FIG. 2, the requirements gathering phase. The first step of gathering requirements is to retrieve the available system documentation (Step 100) of the legacy database system. Referring to FIG. 4, system documents are requested from the client. (Step 100A). It has been learned that existing system documentation will likely be incomplete or out of date. The purpose of gathering documentation is to capture terminology (Step 100B), and, where possible, identify associations between system processes and business processes. (Step 100C). Next, the metadata for the legacy database system (12) is extracted (Step 102). For each table in the existing legacy database system (12), using database connection data provided by the client (Step 102A in FIG. 5), the system connects to the legacy database (12) that is to be migrated. (Step 102B), and extracts the metadata for the connected table (Step 102C) and places the schema information into a metadata database (34) for use during the analysis phases, as discussed below. (Step 102D). In one embodiment of the present invention, the metadata is stored in compliance with the ISO-11179 standard.

Connection parameters for each acquired connection are stored along with the metadata pertaining to each database. (Step 102E). These connection parameters become default connection parameters when performing data analysis and when performing data migration. Once the metadata is acquired from the client's legacy databases (12), those legacy databases (12) can be replicated into the replication database (14). As the final step of Phase 1 (P1), a knowledge base of the legacy system is built (Step 104). Documents that were acquired from the client are placed in the repository (Step 104A in FIG. 6), a Systems Integration Tool (SIT), where they are tracked by name, and associated with major business process areas. (Step 104B). Information systems that are integration targets or which exchange data with integration or migration targets are associated with documents and business processes. (Step 104C). As analysis proceeds, use cases and other design artifacts, and metadata acquired, are classified into major business areas. (Step 104D). In the system of the present invention, a use case is a technique for capturing the potential requirements of a new system or database migration. Each use case provides one or more scenarios that convey how the system should interact with the end user or another system to achieve a specific business goal. SIT is then used by analysts to retrieve and study baseline information about the integration/migration problem and to store, retrieve and perfect analysis of the target integrated environment. SIT facilitates design by keeping analysis artifacts produced in industry standard analysis tools (e.g., UML modeling, Rational tools, etc) closely associated to the information sources contributing to the analysis.

Although Phase 1 (P1) is discussed herein above as a discrete phase of the migration/integration project, it should be understood that each of the four phases and each step of each phase may be revisited, as required, until the legacy system (12) has been finally and completely mapped onto the enterprise system (20). In that fashion, every step of the system of the current invention should be considered iterative.

Upon completion of Phase 1 (P1), Phase 2 (P2), studying and understanding the existing data and processes is commenced. It is within this phase that requirements analysis is an ongoing, iterative concern of the analyst and the design team. Numerous software tools may be brought to bear during this phase including UML modeling tools, software requirements tools, testing tools, etc. A product of Phase 2 is the identification and development business objects (22) through analysis of the client's business functions and legacy database systems (12). In addition to creating business objects (22) to represent real world entities the client uses when performing work, a data analyst determines functional dependency (i.e., data that belongs with or is determined by other data) and creates attributes for the business objects in keeping with database principles such as normalization, storage and retrieval efficiency, etc.

The first step of Phase 2 (P2) is to identify the actors within the legacy database system (Step 106). This analytical process is typically accomplished with Unified Modeling Language (UML) modeling, an object modeling and specification language used in software engineering and is vital to ensuring complete capture of software requirements, actors involved in the information technology (IT) process are identified and documented. These may be system users, customers, other computer systems, widgets, etc., and are real world things that users work with or on. Many of these identified actors will be represented as business objects (22) during the data design effort of Step 110, below. Next, data and process associations are identified (Step 108). In this step, analysts determine how, when, and by whom information about actors or business objects enters the workflow, and how, when, and by whom the data is used and for what purpose.

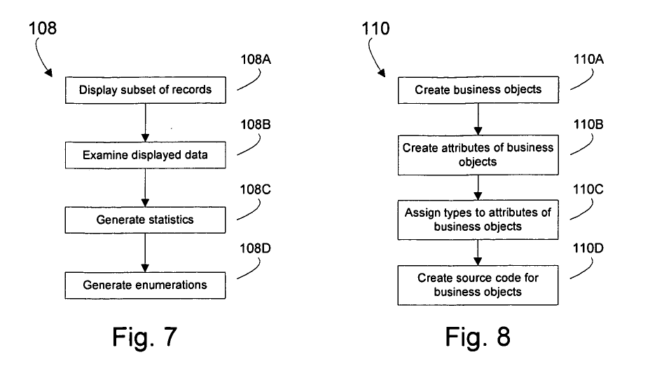

To facilitate understanding of the data, the analyst is presented with a sample data screen where a subset of records is displayed for a legacy data table. (Step 108A in FIG. 7). The data analyst examines a sample of data values to better understand the data element. (Step 108B). Also, the analyst may optionally generate a statistical summary of a data element, showing the mean, standard deviation of numeric fields, the range, uniqueness and a distribution of values. (Step 108C). The sample data grid allows the data analyst to automatically generate enumerations for fields with a limited number of discrete possible data values, enhancing data quality and normalization of the target database. (Step 108D).

Next, the business objects of the target database system are designed and created (Step 110). In concert with the systems analyst, the data analyst creates the business objects determined during the process analysis of Step 108, (Step 110A), and creates attributes for each of the business objects. (Step 110B). As attributes are created, the data analyst will typically use the legacy metadata available to assist in determining appropriate data typing of attributes. (Step 110C). In the most common case, the data type of the legacy field (18) to be migrated will remain the same when represented as an attribute (24) of a business object (22). For example, a person's last name may be stored in a 20 byte character string in the legacy database (12). It is reasonable, then, for the “last name” attribute (24) of the Person business object (22) to be defined as a 20 byte character string. However, the design of the business objects is a mutable model of the current understanding of the target data requirements as explicated by clients, systems analysts, and data analysts. It may be determined later in the migration process that it would be more appropriate to expand the “last name” attribute of the Person business object to 30 bytes. Once the initial model is created, source code for creating the underlying business objects and SQL source code for storing data can be created, allowing application developers to begin working on implementation of the enterprise system. (Step 110D).

In Phase 3 (P3), the legacy fields (18) of the legacy databases (12) are mapped to attributes (24) of the business objects (22). In this phase, data elements present in the legacy databases (12) are linked to target attributes (24) in business objects (22), to specify where existing data will be copied when the migration is actually performed. Data typing checks are performed for each link as it is specified to ensure it is possible to reliably store the existing legacy data values in the target attributes.

Initially, it is expected that every legacy field (18) in the legacy database systems (12) will be migrated and stored somewhere in the new enterprise database system (20). However, during analysis, it will be determined that some fields should not be copied to the new database system (20). These may be fields that are no longer used, or fields whose purpose is to provide configuration support to legacy systems and thus have no role in the new application. In the method of the current system (10), these fields must be marked with a “do not migrate” flag, showing that the legacy field was reviewed and it was determined that the field should not be migrated. Some fields, calculated when used, may be more appropriate to represent not as attributes of business objects, but as database views. An example of this type of field is a data field that is a count or aggregation of other data elements. These types of fields can be more reliably calculated when needed than stored as data. These fields may be marked “represent as view”.

Generally, the data analyst must account for every legacy data field (18), either by specifying a target attribute as it's destination during migration, by marking the field as “do not migrate” or “represent as view.” The data analyst will typically work with clients and system analysts to understand data elements and perform the correct linking to target attributes.

The first step of the mapping phase (P3) is to iteratively map legacy elements to business objects and attributes (Step 114). The system of the present invention recognizes two levels of associating data from the legacy database systems (12) to the new business objects (22). The first level is mapping, in which a data element is known to be functionally dependent on a business object. Here, the data analyst links the legacy field (18) to the business object (22), without determining, at that time, how to store the data element. That is, the legacy field (18) is associated with a business object (22) but the determination as to which attribute (24) within the business object (22) will receive the data is put off until later. This creates a “pile” of data elements that is smaller and interrelated (i.e., related to the particular business object), so the analyst can better determine where legacy fields (18) are duplicated or where additional attributes(24) may need to be defined for a business object (22). Because a business object (22) stores attributes (24), not data, it cannot be a final destination for data. Therefore, mapping is an intermediate step in data analysis, which allows related data elements to be grouped together, in a business object, for further analysis.

An example of the above “mapping” process is the mapping of street addresses. The client may store addresses in multiple data fields in the legacy database system (12), across many different data systems. As the data analyst evaluates data migration requirements, he may map all address fields (address, city, state, zip, county, country, etc.) from each legacy database (12) to the new business object (22), called “Address.” In the legacy databases (12), these fields may be different sizes (e.g., city may be 17 bytes in one system and 21 bytes in another). At this time, the analyst is ensuring that related data is associated with the proper business object (22) to facilitate detailed analysis later. The result is that all the address-related legacy fields (18) are mapped to the Address business object and can be evaluated at a later time to determine to which attribute (24) the legacy fields (18) should be migrated.

The second level of associating data from the legacy database (12) to the business objects (22) is attributing. Attributing is the process by which a legacy data field (18) is linked to a particular and unique attribute (24) of a business object (22), providing a destination for copying old data into new attributes (24). During attributing, the analyst identifies the destination attribute (24) for each legacy data field (18), and resolves any data conversion issues. Because attributes store data they are final destinations for data values from legacy systems.

Referring to example above, the analyst may attribute the 17 byte city field and the 21 byte city field to the attribute (24) called “City” of the business object (22) called “Address.” The analyst does not need to search thousands of legacy fields (18) to find these existing city fields, as they are already available to the Address business object, as mapped elements. As the analyst attributes each city field to the City attribute, appropriate conversions from the old data type to the new data type are specified as needed. For example, in a legacy database, the zip code may be stored as a long integer. To accommodate the new 5+4 zip codes, the enterprise system may store zip codes as 10 byte character strings. Therefore, a conversion from a long integer to a character string must be specified for the migration.

Mapping and attributing are used iteratively to quickly associate legacy data fields (18) with appropriate business objects (22) and attributes (24) therein. The general technique for associating a large number of legacy data fields (18) will be to indicate what business object (22) should have responsibility for each data element (i.e., mapping) by determining functional dependency, then to look at each business object (22) in turn, attributing data elements for that business object (22) to appropriate attributes (24) in the business object (22). This “divide and conquer” approach allows the data analyst to quickly determine for what data elements additional functional dependency information is required, thus frontloading the information gathering requirement.

After the legacy data fields (18) have been mapped to business objects (22) and attributed to attributes (24), the existing mappings/attributes are leveraged to locate new associations and attributes (Step 116). During the data mapping step (Step 114), the data analyst can use mappings and attributions already performed to discover additional relationships that may not have been known during the original business object (22) design. Legacy systems were not constructed randomly. They may not be optimal, but they solved a problem or they would not be in use. Data in a record has some relationship to other data in the same record, whether a functional dependency exists or not. As legacy fields (18) are mapped, the analyst may find that other unmapped fields belong in the same business object (22), or in some related business object (22). The graphical representation of data mapping and attribution provided to the analyst facilitates the discovery of these previously unknown functional dependencies and interrelationships.

It is noteworthy that the data and systems analysts will move back and forth between Phase 1 (P1), Phase 2 (P2), and Phase 3 (P3), in an iterative fashion, and move between activities within each phase, to iteratively arrive at a complete data mapping from the legacy systems (12) to the new target environment (12).

The final step of the mapping phase (P3) is to create the extract-transform-load (ETL) script, (Step 120), which will be used to migrate data from the legacy database systems (12) to the enterprise database (20). The ETL is also known as the migration script (26). When the iteratively developed business object model and data migration is fully specified and all legacy data elements having been accounted for, a migration script is then produced. This migration script provides the detailed plan of how data is going to be read from the legacy systems, how the data will be stored in the replication database (14) and how the data will be stored in the enterprise database (20).

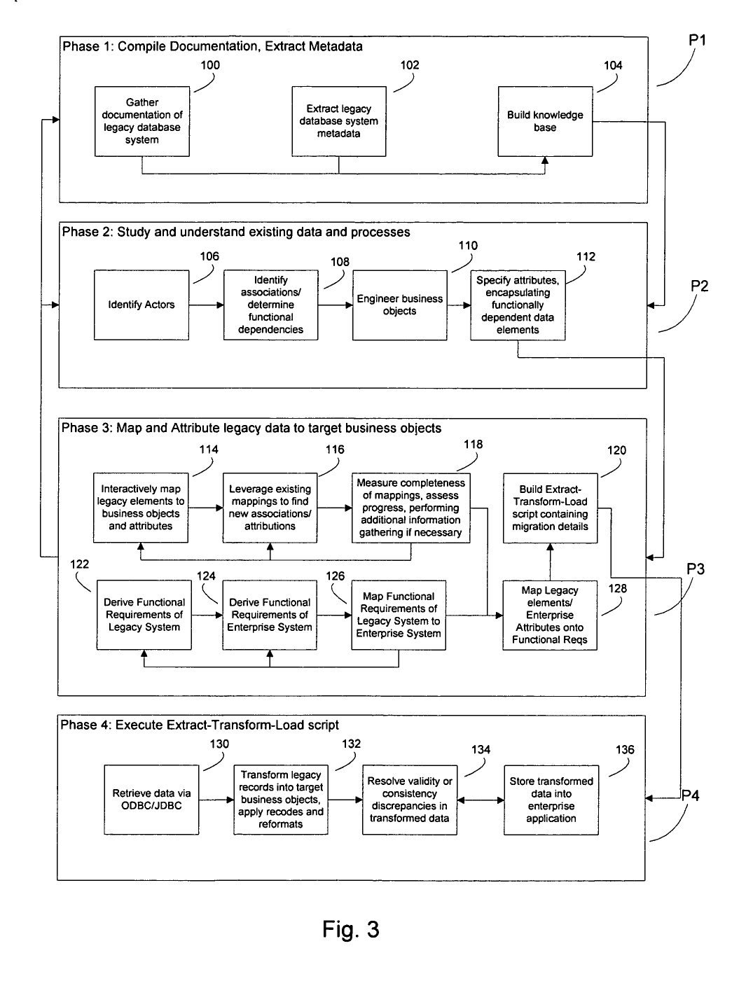

Referring to FIG. 3, it is seen an alternate embodiment of the method of the current system in which Phase 3 (P3) entails a parallel effort to relate the function requirements of the legacy database system (12) to the functional requirements of the enterprise system (20) and, thereby, add another level of understanding to the migration system and reliability to the migration process. It is seen that the functional requirements of the legacy system (12) are derived from the existing documentation, metadata, and source code. (Step 122). Next, the functional requirements of the enterprise system (20) are derived. (Step 124). Ideally, the functional requirements of the enterprise system (20) should be well-defined. The functional requirements of the legacy system (12) are then mapped to the functional requirements of the enterprise system (20). (Step 126). Each legacy data field (18) and each attribute (24) of each business object (22) is then mapped to a functional requirement and is flagged as a produced element (i.e., recipient of information) or a consumed element (i.e., source of information). (Step 128). When all legacy data fields (18) and attributes (24) have been successfully mapped to a functional requirement, it is believed that the migration effort will be more likely to succeed.

In Phase 4 (P4), the migration script (26) generated in Phase 3 (P3) is executed. The migration script is typically comprised of human readable text but may also be machine readable object code. The script provides a detailed set of instructions describing how the data migration will be performed, and can be modified with special rules if necessary.

The first step of Phase 4 (P4) is to retrieve the legacy data from the legacy databases (12) and store that data in the replication database (14). (Step 130). Using the connection parameters provided in Phase 1 (P1), when the metadata was acquired from the legacy database systems (12), the data itself is acquired. To protect the integrity of the data of the legacy system, a snapshot of the data is stored in a temporary database named a replication database (14), which prevents undesirable changes on live/production client data. Next, the legacy fields (18) are copied to attributes (24) in business objects (22). (Step 132). The system applies the plan developed by the data analyst, as embodied in the migration script (26), to the legacy data stored within the replication database (14). Data is read from the replication database (14) and is transformed, as needed, into attributes (24) of the business objects (22) specified as mapping and attribution destinations. Next, any validity or inconsistency discrepancies are resolved (Step 134).

As the system loads data from the replication database (14), transforms the data, and stores the transformed data in the target enterprise database (20), each transformation and attribute storage is verified by the system to ensure no inconsistencies or errors occurred in the transformation or migration process. Any errors or inconsistencies are recorded in an exception database (36), along with all pertinent data for researching the original data record and the potential target business object. These data issues must be resolved by an analyst to complete the migration process. Typical problems are null values in required fields, failures to convert (e.g., legacy data containing the letter ‘O’ instead of the number ‘0’; failing to convert to an integer value), failures to truncate (e.g., a string with 22 characters of information being migrated to an attribute defined to be 20 characters), and the most troublesome problem of all, two different, equally valid values in two different systems for the same data element.

For example, if for a given Person business object, the birth date is observed as “06-08-1966” in one legacy data element, then observed later as “08-06-1966” in some other legacy system, a value exception has occurred. The analyst may be able to resolve this inconsistency by looking at other data, or by studying distributions of each of these values across the source data elements containing birth date.

When these various data exceptions can be resolved directly from the exception database, the migration does not need to be re-executed to resolve the problems, and the legacy data does not need to be corrected.

When all exceptions have been either resolved or intentionally ignored, the stored, migrated data is transferred to the enterprise application (Step 136) and the migration is complete.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

What is claimed is:

1. A method of migrating one or more legacy database systems to one or more target database systems, the method comprising:
gathering design information about the legacy database system, the design information including metadata, fields, relationships, and schema;
analyzing existing metadata, data fields, and processes;
creating business objects for the one or more target database, the business objects comprising attributes;
associating one or more of the fields of the legacy database system to one or more of the business objects;
creating a data migration script, the script executable by a computer to transfer data from the chosen fields of the legacy database systems to the one or more target database systems;
executing the data migration script; and
resolving inconsistencies between the legacy database systems and the one or more target database systems.

2. The method of claim 1 wherein the step of gathering design information comprises the steps of:
gathering system documentation for the legacy database system to capture terminology and identify associations between system processes and business processes;
retrieving schema information about at least one of the database in the legacy database system;
storing the schema information in a metadata database;
saving connection parameters for each legacy database; and
associating the legacy database system with the gathered system documentation.

3. The method of claim 1 wherein the step of analyzing existing metadata, data fields and processes comprises the steps of:
identifying a multiplicity of actors involved in the legacy business process, the actors including users, customers, and outside computer systems;
identifying associations between the multiplicity of actors and one or more business functions of the legacy database systems; and
identifying zero or more functional relationships between the fields of the legacy database systems.

4. The method of claim 3 wherein the step of identifying functional relationships between the fields of the legacy database system is performed by one of legacy proximity, semantic similarity, and distributional similarity.

5. The method of claim 1 wherein the business objects for the one or more target database systems represent the business functions of the target database system and the attributes have a data type.

6. The method of claim 1 wherein the step of iteratively associating fields of the legacy database system comprises the steps of:
determining by functional dependency into which one or more of the business objects each of the one or more fields of the legacy database system should be migrated;
attributing each of the one or more fields of the legacy database system with one or more attributes of the one or more determined business objects;
reviewing current mappings of legacy database fields to business object attributes to locate undocumented mappings; and
identifying fields in the legacy database system which will not be migrated to any of the one or more target database systems.

7. The method of claim 1 wherein the step of executing the data migration script comprises the steps of:
copying the legacy database systems into a replication database system to prevent undesired changed to the live legacy database system; and
copying values in the replication database system to the attributes of the business objects of the one or more target database systems.

8. The method of claim 1 wherein the step of resolving inconsistencies comprises the steps of:
determining if errors or inconsistencies were introduced into the one or more target database systems during the copying step;
storing located errors or inconsistencies in an exception database; and
resolving the errors or inconsistencies stored in the exception database.

9. A method of migrating one or more legacy database systems to one or more target database systems, the method comprising:
gathering system documentation for the legacy database system to capture terminology and identify associations between system processes and business processes;
associating the legacy database systems with the gathered system documentation;
identifying a multiplicity of actors involved in the legacy business process, the actors including users, customers, and outside computer systems;
creating business objects for the one or more target database systems, the business objects comprising one or more attributes, the attributes having a data type;
associating one or more of the fields of the legacy database system to one or more of the business objects;
identifying fields in the legacy database system which will not be migrated to any of the one or more target database systems;
creating a data migration script, the script executable by a computer to transfer data from the fields of the legacy database systems to the one or more target database systems;
copying values in the replication database system to the attributes of the business objects of the one or more target database systems; and
determining if errors or inconsistencies were introduced into the one or more target database systems during the copying step.

10. The method of claim 9 wherein after the step of gathering system documentation is the step of gathering information about the legacy database system.

11. The method of claim 10 wherein the step of gathering information about the legacy database system comprises the steps of:
retrieving schema information about at least one database in the legacy database systems;
storing the schema information of the at least one database in a metadata database; and
saving connection parameters for each of the at least one legacy database

12. The method of claim 9 wherein after the step of identifying a multiplicity of actors is the step of identifying associations between the multiplicity of actors and one or more business functions of the legacy database system.

13. The method of claim 12 further including the step of identifying functional relationships between fields of the legacy database using one of legacy proximity, semantic similarity, and distributional similarity.

14. The method of claim 9 wherein after the step of creating business objects are the steps of:
deriving the functional requirements of the legacy database system;
deriving the functional requirements of the target database system;
mapping the functional requirements of the legacy database system to the functional requirements of the target database system; and
mapping each field of the legacy database system to a functional requirement and identifying that field as a source of data or a recipient of data; and
mapping each attribute of each business object of the target database system to a functional requirement and identifying that field as a source of data or a recipient of data.

15. The method of claim 9 wherein the step of iteratively associating each of the fields of the legacy database system to one or more of the business objects comprises the steps of:
determining by functional dependency into which one or more of the business objects each of the one or more fields of the legacy database system should be migrated;
attributing one or more fields of the legacy database system with one or more attributes of the one or more determined business objects; and
reviewing current mappings of legacy database fields to business object attributes to locate undocumented mappings.

16. The method of claim 16 wherein after the step of identifying fields in the legacy database system that will not be migrated is the step of ensuring that each field in the legacy database system is either attributed to an attribute in one or more business objects or identified as not being migrated.

17. The method of claim 16 wherein before the step of copying the legacy database systems is the step of copying the legacy database systems into a replication database system.

18. The method of claim 17 wherein after the step of determining if errors on, inconsistencies were introduces are the steps of:
storing located errors or inconsistencies in an exception database; and
resolving the errors or inconsistencies stored in the exception database.

19. A method of migrating one or more legacy database systems to one or more target database systems, the method comprising::
gathering system documentation for the legacy database systems to capture terminology and identify associations between system processes and business processes;
retrieving schema information about one or more databases in the legacy database system;
storing the schema information for the one or more legacy databases in a metadata database;
saving connection parameters for each of the one or more legacy databases;
associating each of the one or more legacy databases with the gathered system documentation;
identifying a multiplicity of actors involved in the legacy business process, the actors including users, customers, and outside computer systems;
identifying associations between the multiplicity of actors and one or more business functions of the legacy database system;
identifying functional relationships between fields of the one or more legacy databases using one of legacy proximity, semantic similarity, and distributional similarity;
creating business objects for the one or more target database systems, the business objects comprising attributes, the attributes having a data type;
determining by functional dependency into which one or more of the business objects each of the one or more fields of the legacy database system should be migrated;
attributing one or more fields of the legacy database system with one or more attributes of the one or more determined business objects;
reviewing current mappings of legacy database fields to business object attributes to locate undocumented mappings;
identifying zero or more fields in the legacy database system which will not be migrated to any of the one or more target database systems;
ensuring that each field in the legacy database system is either attributed to an attribute in one or more business objects or identified as not being migrated;
creating a data migration script, the script executable by a computer to transfer data from the fields of the legacy database systems to the one or more target database systems;
copying the legacy database systems into a replication database system;
copying values in the replication database system to the attributes of the business objects of the one or more target database systems;
determining if errors or inconsistencies were introduced into the one or more target database systems during the copying step;
storing located errors or inconsistencies in an exception database; and
resolving the errors or inconsistencies stored in the exception database.

20. The method of claim 19 wherein before the step of creating a data migration script are the steps of:
deriving the functional requirements of the legacy database system;
deriving the functional requirements of the target database system;
mapping the functional requirements of the legacy database system to the functional requirements of the target database system; and
mapping each field of the legacy database system to a functional requirement and identifying that field as a source of data or a recipient of data; and
mapping each attribute of each business object of the target database system to a functional requirement and identifying that field as a source of data or a recipient of data.
